(19) United States
(12) Patent Application Publication
(10) Pub. No.: US 2003/0025681 A1
(43) Pub. Date: Feb. 6, 2003

(54) Electronic whiteboard and electronic whiteboard system including the same

(76) Inventor: Naozumi Hara, Fukuoka (JP)

Correspondence Address: Lawrence E. Ashery, RatnerPrestia, PC, One Westlakes (Berwyn), Suite 301, P.O. Box 980, Valley Forge, PA, 19481, US

(21) Appl. No.: 10/174,440

(22) Filed: Jun. 18, 2002

(30) Foreign Application Priority Data
Jun. 26, 2001 (JP) 2001-192226

(51) Int. Cl. G09G 5/00

(52) U.S. Cl. 345/178; 345/803

(57) ABSTRACT

Disclosed is an electronic whiteboard system in which a screen-changing operation works on changing screen of the whiteboard, at the same time, works on creating a new page on a personal computer (PC). In response to the screen-changing operation, the whiteboard changes the screen and transmits a screen-changing code to the PC. Received the screen-changing code, the PC automatically creates a new page. Similarly, in response to scanning operation, the whiteboard transmits a scanning code and a scanned image to the PC. Received the scanning code and the scanned image, the PC creates a new page and stores the scanned image at the same time.

### FIELD OF THE INVENTION

The present invention relates to an electronic whiteboard and an electronic whiteboard system including the same, more particularly, relates to an electronic whiteboard system capable of, with a coordinates-detecting technology, obtaining information handwritten on a screen of an electronic whiteboard; transmitting the information to a computer via a communicator; and virtually reproducing the writings on the screen by the computer.

### BACKGROUND OF THE INVENTION

An electronic whiteboard system equipped with an “interactive” function below has become a familiar sight in recent years: such system employs a coordinates-detecting technology with which a writing position on a screen of the electronic whiteboard is automatically detected; and transmits traces written with a marker pen on the screen to a personal computer (hereinafter referred to as a PC) in real time; then virtually reproduces the screen of the electronic whiteboard on PC's software.

Another prior-art electronic whiteboard system with a screen-scanning function can scan the screen handwritten with a marker pen (not in real time but as necessary) and transmit the scanned images to a PC.

Here will be described how such an electronic whiteboard system works with reference to FIGS. 11 and 12.

FIG. 11 shows a schematic block diagram of a typical prior-art electronic whiteboard system, where electronic whiteboard 111 is connected to PC 112 via communications cable 113.

Now will be described the coordinates detection indispensable for the interactive function.

Two coordinates-detecting sensors 115 receive infrared light and ultrasound that are simultaneously emitted from electronic pen 114 designed specifically for the electronic whiteboard. Difference between the receiving time of the infrared light and the ultrasound allows each of sensors 115 to calculate each distances from pen 114. Sensors 115 are disposed at the top corners on the screen of electronic whiteboard 111, that is, the distance between two sensors is already known. Therefore, the location of pen 114 can be trigonometrically determined and represented as coordinates, with upper left corner of the screen defined the origin.

The coordinates information obtained through the calculation above is now transmitted one after another in real time to PC 112 via cable 113. Receiving the information from the sensors, software 116 of PC 112 reproduces handwritings on the screen according to the coordinates information. In the system, handwritings with different colors can be reproduced by allowing sensors 115 to detect not only coordinates information but also color information, which was added to infrared light emitted from pen 114, and to transmit them to the PC.

Furthermore, the prior-art includes an electronic whiteboard having a plurality of screens. According to such a system, pressing a button placed in operating section 117 shown in FIG. 11 scrolls the writings-bearing screen until a blank screen is placed in front of the whiteboard.

FIG. 12 is a view that can be seen in a program running on the PC for the prior-art electronic whiteboard system. The view represents that software 116 on PC 112 has captured three pages of the screens of electronic whiteboard 111. As mentioned above, software 116 handles each screen as a page. Window 121 placed lower in the view shows thumb-nailed whole pages. On the other hand, window 122 shows the page corresponding to a now-in-use screen of whiteboard 111. Software 116 reproduces the screen of the whiteboard onto the page shown in window 122 according to the coordinates information received in real time. In such a system, the number of pages of the software does not necessarily correspond to the number of screens of the whiteboard: an electronic whiteboard having a single screen can “renew” the screen by erasing it.

In another example of the prior-art in which electronic whiteboard 111 has a scanning function, the screen is scanned while it is scrolled. A page of the scanned image is transmitted to PC 112 via a communicator. Like the case of screen scrolling described above, the scanning usually starts by pressing a button disposed in operating section 117 of FIG. 11. The scanned image transmitted to PC 112 can be used for a base image of a page of software 116-such a base image can be useful for, for example, a presenter in a conference: firstly, the system, as described above, scans a now-in-use screen while scrolling the screen and transmits the scanned screen to PC 112; the display of PC 112 shows the received image as a base image; the presenter can keep on writing on the screen, while the system transmits in real time the coordinates information on the added writing by the presenter to PC 112 via communications cable 113.

In such structured system, however, software 116 of PC 112 has an inconvenience in that a user cannot add a new page in a series of procedure following the operation for changing screen of the whiteboard. That is, after performing the changing screen operation, the user has to select “creating new page” from another menu included in software 116.

In electronic whiteboard 111 having a scanning function, as described earlier, a screen image that has been scanned and transmitted to PC 112 can be used as a base image of a page in software 116. However, the system also has a problem similar to that described above: the “creating new page” function cannot be performed following the operation for scanning the whiteboard. The structural inconvenience has required the user to select the function as another procedure in software 116 of PC 112.

### SUMMARY OF THE INVENTION

The present invention addresses the problems above. It is therefore an object of the present invention to provide an electronic whiteboard system equipped with a user-friendly function, by which a PC automatically creates a new page responsive to the screen-changing operation and lets the system go into a standby mode for receiving coordinates information from the whiteboard, at the same time, by which a screen image becomes available for a base image for pages stored in the PC in response to the whiteboard-scanning operation.

To achieve the object, the present invention provides an electronic whiteboard with a communicator that communicates with programs on the PC. The communicator transmits to a program on the PC the screen changing and scanning operations executed through the operating section of the whiteboard as communications data. Besides, if the communications data is judged as the scanning operation, the communicator transmits the scanned image together.

The program on the PC has a communicator for receiving and analyzing the communications data transmitted from the whiteboard. If the transmitted data is determined as a code for changing screen, the program allows the system to automatically create a new page and go into a standby mode for receiving writing data from the whiteboard. If the transmitted data is determined as a code for scanning, the program allows the system to automatically create a new page, receive the scanned image from the whiteboard, and store the image as a base image for a page.

According to the present invention, a screen-changing command doubles as the operation for changing screen of the whiteboard and the creating new page operation working on the program of the PC, so that a user can keep writing on the screen with no interruption. In addition, a whiteboard-scanning command performs the new-page creating and base-image storing operations on the program on the PC at the same time. With the improvements, a presenter can resume a conference, referencing to the screen retaining previous writings thereon.

### BRIEF DESCRIPTION OF THE DRAWINGS

FIG. 1 is a block diagram illustrating functions of an electronic whiteboard in the preferred embodiment of the present invention.

FIG. 2 is a block diagram illustrating functions of a personal computer (PC) in the embodiment.

FIG. 3 shows an example of information stored in a document information-storage section in the embodiment.

FIG. 4 shows an example of strokes making up a character in the embodiment.

FIG. 5 shows an example of stroke information on a character in the embodiment.

FIG. 6 is a flow chart illustrating steps performed in the operating section of the electronic whiteboard in the embodiment.

FIG. 7 is a flow chart illustrating steps performed when the switch of an electronic pen is in ON-state.

FIG. 8 is a flow chart illustrating the routine for processing communications data by software on the PC in the embodiment.

FIG. 9 is a flow chart illustrating the routine for processing control data by software on the PC in the embodiment.

FIG. 10 is a flow chart illustrating the routine for processing writing data by software on the PC in the embodiment.

FIG. 11 schematically illustrates the configuration of a prior-art electronic whiteboard system.

FIG. 12 schematically illustrates a view seen in a software program on a PC of the prior-art electronic whiteboard system.

### DESCRIPTION OF THE PREFERRED EMBODIMENTS

The preferred embodiment of the present invention is described hereinafter with reference to the accompanying drawings.

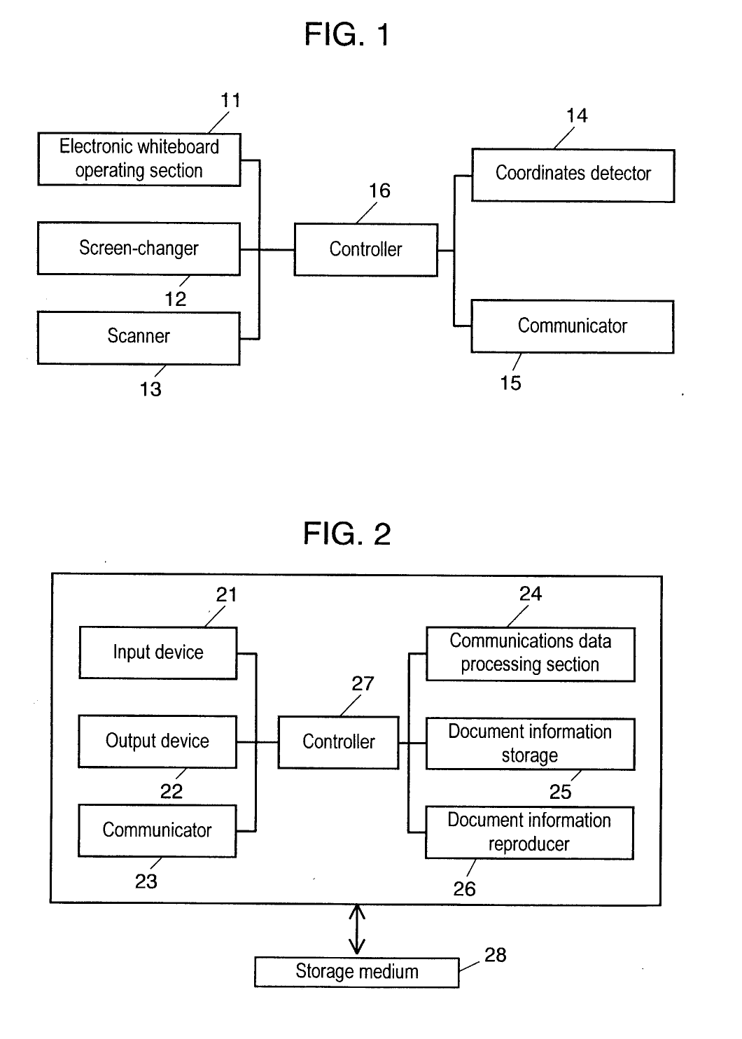

According to the embodiment of the present invention, the electronic whiteboard system contains an electronic whiteboard illustrated in FIG. 1 and a personal computer (PC) illustrated in FIG. 2. FIGS. 1 and 2 are block diagrams illustrating functions of the electronic whiteboard and the PC, respectively, in the embodiment.

The electronic whiteboard in FIG. 1 of the embodiment includes: i) whiteboard operating section 11 for inputting screen-changing and scanning commands; ii) screen-changer 12 for executing screen changing in response to the screen-changing command; scanner 13 for executing scanning in response to the scanning command; iii) coordinates detector 14 for detecting, in combination with a coordinates-detecting sensor, the location of an electronic pen as coordinates on the screen; iv) first communicator 15 for exchanging data with the PC shown in FIG. 2; and v) controller 16 for governing the whole system.

On the other hand, the PC in FIG. 2 of the embodiment includes: i) input device 21 such as the keyboard and mouse; ii) output device 22 typified by the cathode-ray tube (CRT); iii) second communicator 23 for exchanging data with the electronic whiteboard illustrated in FIG. 1; iv) data processing section 24 for judging the data transmitted from the whiteboard and determining following procedures; v) document information storage 25 for storing data in such a way that a screen having writings thereon at any given time is filed as a page and such accumulated pages are organized as a document; vi) document information-reproducer 26 for reproducing the screen onto the window of a display of output device 22 according to the document information stored in storage 25; and vii) controller 27 for controlling whole procedures through executing programs. The programs are loaded from storage medium 28 in which the programs are stored. Storage medium 28 may be built-in or an external add-on device to the PC.

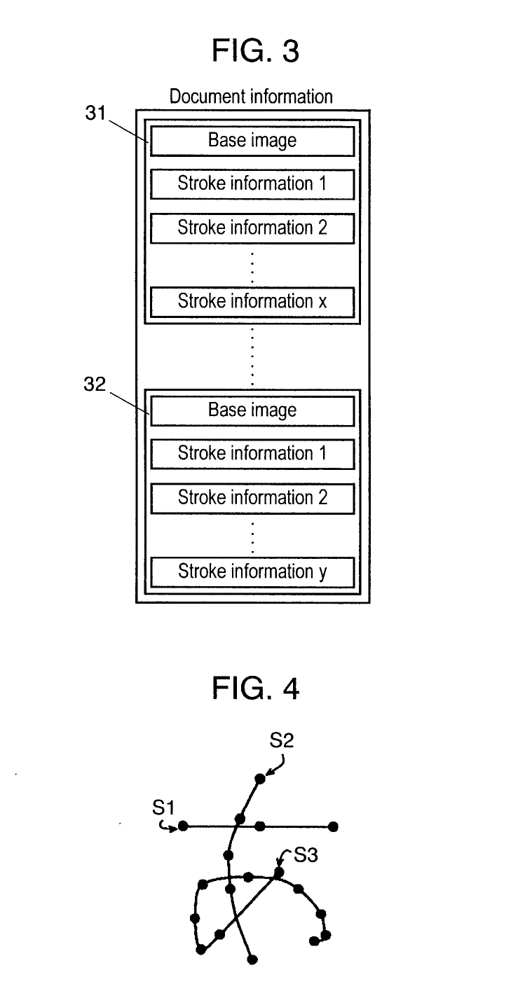

FIG. 3 shows an example of information stored in document information storage 25. Storage 25 retains information segmented by pages—first page information 31 and following page information 32 as necessary. Each of information 31 and 32 is formed of single base image and stroke information containing an arbitrary number of strokes. The base image is used for the background of a page, on which all strokes are overlaid. The stroke information contains data necessary to reproduce stroke-to-stroke writing written with an electronic pen on the whiteboard.

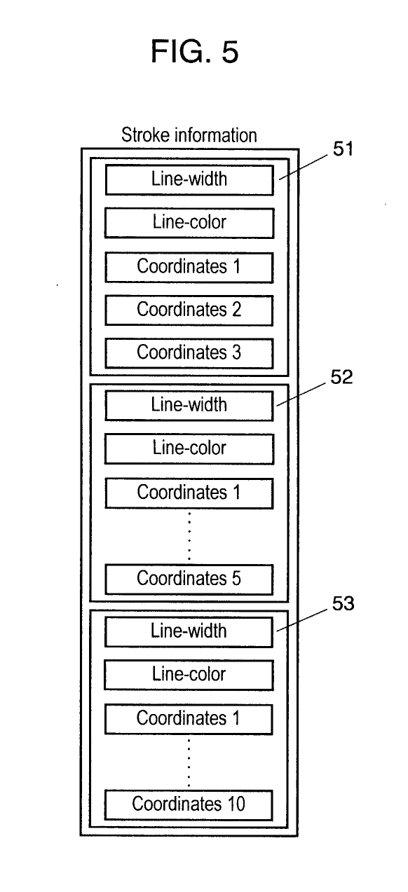

FIG. 4 is an example showing the strokes included in the Japanese hiragana-character, “ [symbol] ”, while FIG. 5 is an example of stroke information on the character “ [symbol] ”. The character “ [symbol] ” is divided into three strokes S1, S2, and S3, each of which is associated with stroke information 51, 52, and 53, as shown in FIG. 5. Each of stroke information 51, 52, and 53 includes line-width, line-color, and at least two coordinate data. Stroke information 51 retains each coordinate data for three points indicated by black dots on stroke S1. Similarly, information 52 retains coordinate data for five points on stroke S2, and information 53 retains data for ten points on stroke S3.

With stroke information 51 through 53 in FIG. 5, the hiragana-character “ [symbol] ” shown in FIG. 4 can be reproduced in a two-dimensional space, such as a window on a PC. That is, downward-connecting the three points (coordinates) with each line-width and line-color, which are stored in stroke information 51, can reproduce stroke S1. Similarly, strokes S2 and S3 can be reproduced from stroke information 52 and 53. In the reproduction process, lines connecting between the points may be straight, or may be an approximate curve including a Bezier curve, as long as the writing reproduced has similarity with the original writing on the screen with the electronic pen.

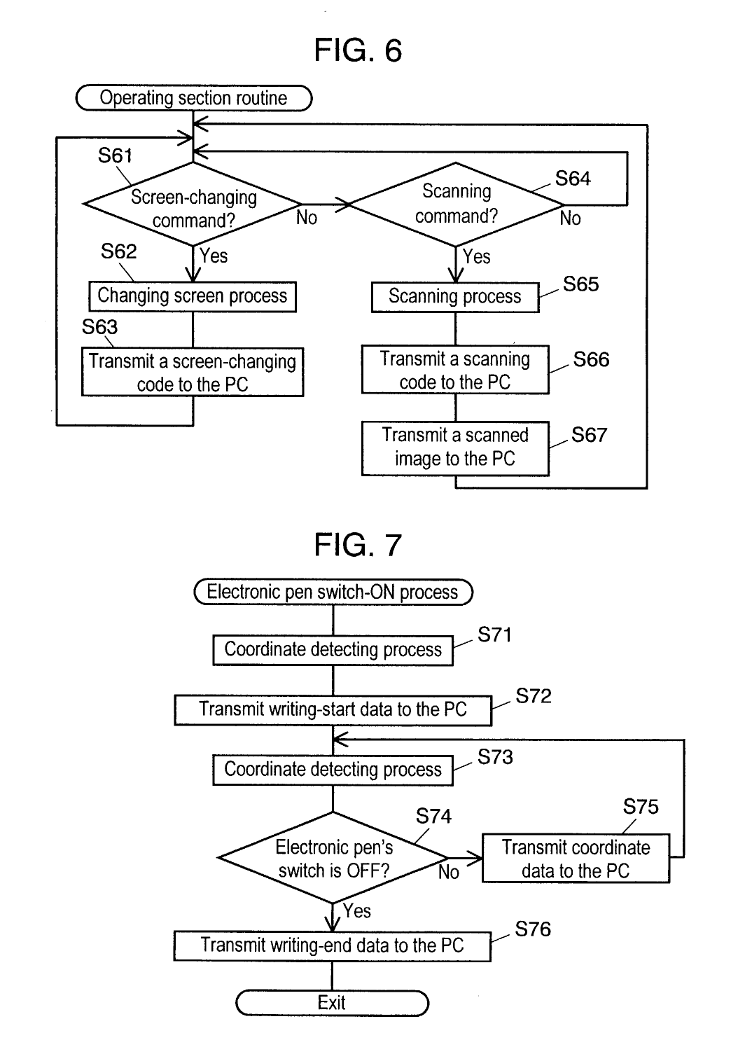

Now will be described the process flow in the embodiment of the present invention with reference to the flow charts illustrated in FIG. 6 through FIG. 10.

FIG. 6 is a flow chart of a routine in the operating section 11 of the whiteboard shown in FIG. 1 when the operating section accepts the screen-changing or scanning commands.

In step S61, if the input is the screen-changing command, screen-changer 12 changes the screen in step S62 and communicator 15 transmits the screen-changing code to the program on a PC in step S63. If the input is not judged as the screen-changing command in step S61 but as the scanning command in step S64, scanner 13 scans screen in step S65, and communicator 15 transmits a scan code indicating the completion of scanning to the PC in step S66 then transmits the scanned image to the PC in step S67.

FIG. 7 is a flow chart of a routine when the user writes with the electronic pen on the screen with the switch of the electronic pen turned ON.

When the switch of the pen is turned ON, that is, when the coordinate detecting sensors get ready for detecting, coordinate detector 14 shown in FIG. 1 detects the position of the pen as the coordinate data in step S71. In step S72, communicator 15 transmits the detected data as writing-start data to a program on the PC. After the coordinates are detected in step S73, the pen is checked whether the switch is ON or OFF in step S74. If the switch is still ON, communicator 15 transmits the detected data the PC in step S75 and the procedure reenters step S73. Steps S73 through S75 are continued while the switch is being ON. When the switch turns OFF, communicator 15 transmits the coordinate data detected in step S73 to the PC as writing-end data in step S76, then the routine completes. In the routine, the coordinate data is supposed to be transmitted to the PC at least two, not one.

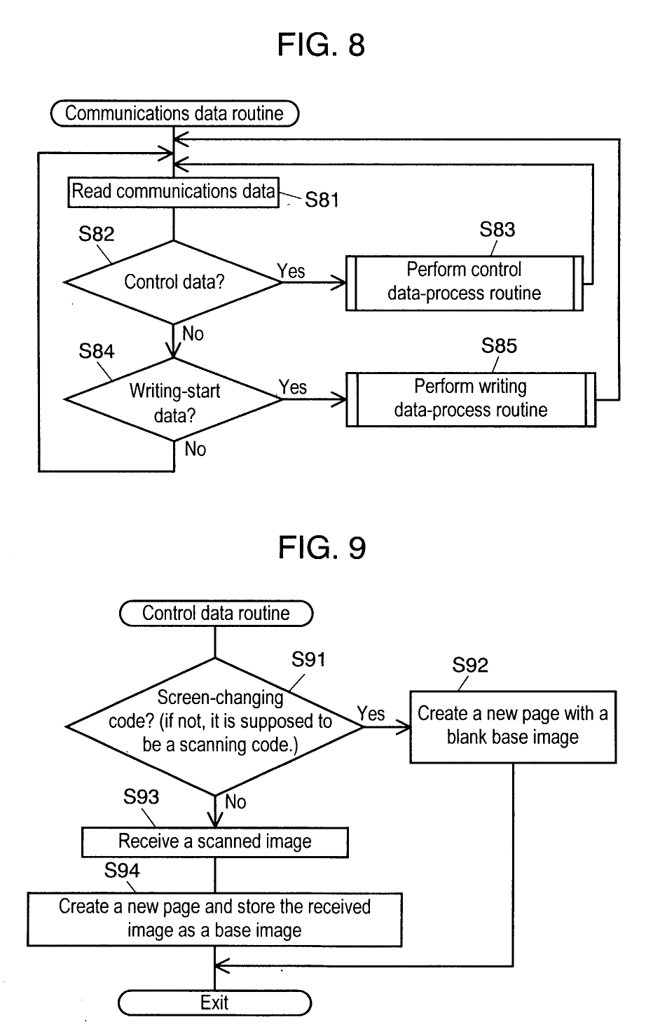

FIG. 8 is a flow chart of a communications data routine, in which communications data is received from the electronic whiteboard through a program on the PC. In step S81, communicator 23 shown in FIG. 2 reads the communications data from the whiteboard and sends it to communications data-processing section 24 shown in FIG. 2. In step S82, if the received data is a control code—which is supposed to be either a screen-changing code or a scanning code, the procedure enters the control data process in step S83. In step S84, if the received data is writing-start data, the procedure enters the writing data process in step S85.

FIG. 9 is a flow chart of a control data routine of the program on the PC, which gives detail explanation of the control data process of step S83 in FIG. 8. In step S91, if the control data is a screen-changing code, the PC creates a new page having a blank base image in the document information shown in FIG. 3, and then the procedure exits the routine to return to the communications data routine. On the other hand, if the control data is a scanning code in step S91, the PC receives a scanned image from the whiteboard in step S93. In step S94, the PC creates a new page in which the scanned image is stored as a base image in the document information in FIG. 3, and then the procedure exits the routine to return to the communications data routine.

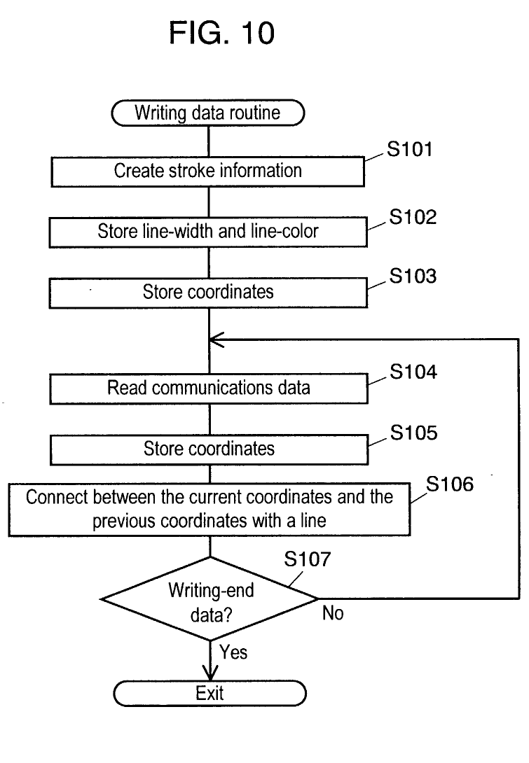

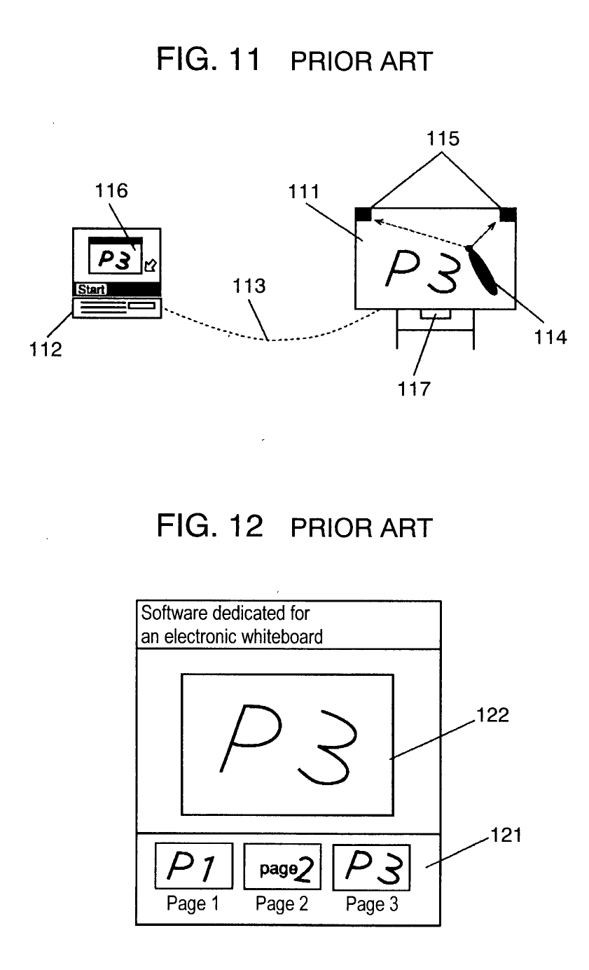

FIG. 10 is a flow chart of a writing data routine of the program on the PC, which gives detail explanation of the writing data process of step S85 in FIG. 8. Receiving writing-start data from the whiteboard starts the routine. In step S101, add new stroke information to the document information shown in FIG. 3. In step S102, a line-width and a line-color are stored into the added stroke information as shown in FIG. 5. How to detect a line-width and line-color is relatively insignificant in embodying the present invention and the detailed explanation will be omitted. If a marker is attached to the electronic pen, the width and color of a stroke are automatically defined by the marker: such information can be added to infrared light emitted from the pen. The coordinate-detecting sensor can receive the information and transmit it to the PC as a part of communications data. In step S103, the PC stores coordinate information included in writing-start data into the field of coordinates 1 in FIG. 5.

In step S104, the PC reads next communications data from the whiteboard and store the coordinate information into the field of coordinate 2 in FIG. 5. In step S106, reproducer 26 connects between the coordinates stored in the fields of coordinates 1 and 2 with the line-width and line-color stored in the stroke information to reproduce a part of a stroke. Unless the data is writing-end data in step S107, the procedure reenters step S104 to read the next communications data. Repeatedly performing steps S104 through S106 reproduces the writings with the pen on the screen of the whiteboard onto the window of the PC in real time. When a user needs to rewrite the writing on the window, the user can let the system read the data from the top of the stroke information to reproduce the strokes.

Although the coordinate detection is performed with the electronic pen and the sensor in the embodiment, the detecting way is not limited to: having a coordinate-detecting function is of importance to the present invention. Therefore, coordinate detection with a touch panel system is also acceptable. Similarly, as long as the whiteboard can communicate with the PC, radio communications are acceptable instead of the communications via a communications cable.

The scanning function is not limited to that employed in the embodiment: the scanning by a movable scanner running across the screen is also acceptable.

According to the present invention, as described above, the screen-changing command requested by a user at the whiteboard can change the screen of the whiteboard and create a new page on the PC at the same time, so that the user can keep writing on the screen with no interruption.

Similarly, the scanning command requested by the user at the whiteboard can perform the new-page creating and base-image storing operations on the PC at the same time. With the improvements, a presenter can resume a conference, referencing to the screen retaining previous writings thereon.

What is claimed is:

1. An electronic whiteboard comprising:
(a) a plurality of screens;
(b) coordinate-detecting means for detecting coordinates of a position pointed by an electronic pen on the screens;
(c) screen-changing means for changing the screens; and
(d) communicating means for transmitting to a computer i) coordinate information detected by the coordinate-detecting means and ii) screen-changing information indicating a completion of changing screens by the screen-changing means.

2. An electronic whiteboard system including an electronic whiteboard, wherein the system receives, from the electronic whiteboard, i) screen-changing information indicating a completion of changing a plurality of screens and ii) coordinate information indicating a position pointed by an electronic pen on the screens, and the system offers screen-by-screen storage, which is based on the screen-changing information, of the writings-bearing screens with the electronic pen at any given time according to the coordinate information.

3. The electronic whiteboard system as defined in claim 2, wherein the electronic whiteboard comprising:
(a) a plurality of screens;
(b) coordinate-detecting means for detecting coordinates of a position pointed by an electronic pen on the screens;
(c) screen-changing means for changing the screens; and
(d) communicating means for transmitting to a computer i) coordinate information detected by the coordinate-detecting means and ii) screen-changing information indicating a completion of changing screens by the screen-changing means.

4. An electronic whiteboard system comprising:
(a) an electronic whiteboard including;
(a-1) a plurality of screens;
(a-2) coordinate-detecting means for detecting coordinates of a position pointed by an electronic pen on the screens;
(a-3) screen-changing means for changing the screens; and
(a-4) an operating section for entering a screen-change command to the screen-changing means; and
(a-6) first communicating means for transmitting coordinate information detected by the coordinate-detecting means and screen-changing information indicating a completion of entry of the screen-changing command;
(b) a computer having second communicating means for receiving the coordinate information and the screen-changing information from the electronic whiteboard; and
(c) a storage medium for storing a program that allows the computer to automatically create a new page on receipt of the screen-changing information; to store a writings-bearing screen at any given time according to the coordinate information; and to retain plural pages as accumulation of a screen-by-screen page.

5. An electronic whiteboard system comprising:
(a) an electronic whiteboard including;
(a-1) coordinate-detecting means for detecting coordinates of a position pointed by an electronic pen on the screens;
(a-2) screen-changing means for changing the screens; and
(a-3) an operating section for entering a screen-change command to the screen-changing means; and
(a-4) first communicating means for transmitting to a computer coordinate information detected by the coordinate-detecting means and screen-changing information indicating a completion of entry of the screen-changing command;
(b) second communicating means for receiving the coordinate information and the screen-changing information from the electronic whiteboard;
(c) reproducing means for virtually generating the screens of the electronic whiteboard on a window and reproducing on the window, according to the coordinate information received from the electronic whiteboard, the writings-bearing screens written with the electronic pen;
(d) a document information storage for storing the screens in such a way that a writings-bearing screen with the electronic pen at any given time is organized on a page-by-page basis and such filed and accumulated pages are organized on a document-by-document basis; and
(e) a storage medium for storing a program that allows the computer to create a new page at any given time in response to a request by a user,
wherein the computer automatically creates a new page on receipt of the screen-changing command and goes into a standby mode for receiving the coordinate information from the electronic whiteboard.

6. The electronic whiteboard system as defined in claim 5, wherein the coordinate-detecting means detects the position pointed by an electronic pen on the screens by receiving ultrasound and infrared light emitted from the pen.

7. The electronic whiteboard system as defined in claim 5, wherein the electronic whiteboard further includes scanning means for scanning information written on the screen; the operating section further includes a function allowing the scanning command for the scanning means to be switch-selectable; the first communicating means further includes a function to transfer a scanned image data to the computer in response to the scanning command; and the program provides the computer with a function for receiving the image data fed from the electronic whiteboard, allowing the image data to be a base image of a page.
